(19) United States
(12) Patent Application Publication
(10) Pub. No.: US 2004/0141312 A1
(43) Pub. Date: Jul. 22, 2004

(54) Headlamp/camera unit, especially for medical uses

(76) Inventors: Wolfram Henning, Allersberg (DE); Karl Melder, Buchen (DE); Frank Schure, Buchen (DE)

Correspondence Address: Lloyd G Farr, Nelson Mullins Riley & Scarborough, PO Box 11070, Columbia, SC, 29211-1070, US

(21) Appl. No.: 10/433,266

(22) PCT Filed: Nov. 29, 2001
(86) PCT No.: PCT/DE01/04469

(30) Foreign Application Priority Data
Nov. 29, 2000 (DE) 100 59 228.7
Nov. 30, 2000 (DE) 100 59 724.6
Jun. 2, 2001 (DE) 101 26 907.2

(51) Int. Cl. F21V 21/084

(52) U.S. Cl. 362/105

(57) ABSTRACT

The invention relates to a headlamp/camera unit, especially for medical uses, comprising at least one lamp, an especially electronic camera, a support device that supports the at least one lamp and the camera on the head of a person, and an optical sighting mechanism that projects at least one aiming mark into the image field of the camera illuminated by the lamp.

### TECHNICAL AREA

The invention refers to a headlamp/camera unit particularly for medical applications.

### STATE-OF-THE-ART TECHNOLOGY

In a variety of fields headlamps, which are worn on a head band, cap or helmet. Their use in mining and for medical and, specifically, for surgical purposes is mentioned here merely to give examples. Headlamps of this type are also used for assembly work.

Headlamps have the advantage of eliminating the precise area that the person wearing them actually sees, without the need for stationary floodlights or handheld lamps.

On the other hand, documentation systems are increasingly being used in medical technology—as well as in other fields. The use of such systems serves the purpose of supplying documentation in case of any liability actions on the one hand, and as a basis for ISO certification on the other. During operations video cameras are used as a rule for such documentation purposes, for filming the actual operating procedure and recording by means of a recorder. Depending on how up-to-date or sophisticated the technology is, these video cameras are located, for example, in the middle of the operating lamp or in some other spot above the operating table. The disadvantage of such a video camera arrangement is that the actual operating field is frequently covered up by the surgeon or persons assisting the surgeon.

If the video camera is not located on or in the centre of the operating lamp there are additional problems due to shadows in the image field, caused by the members of the operating team etc.

Similar problems also arise in other situations in which stationary video cameras are used.

On the other hand, the use of mobile video cameras is more demanding on the camera operators and normally means occupying one person who concentrates only on filming the video.

### PRESENTATION OF THE INVENTION

The purpose of the invention is to create an arrangement, which in almost all instances excludes the possibility of blocking the area on which work is to be carried out and, in particular, the operating field as well as the formation of any shadows and/or filming of any other region than the desired spot. Furthermore, headlamps/camera units are to be designed that facilitate a direct transmission of the images being filmed as well as communication with other workplaces. In addition, in a more advanced version of the invention it should be possible to film from several different perspectives and, in particular, to film in stereo.

Solutions according to the invention are stated in the independent patent claims. Further developments of the invention are the subject of dependent claims.

According to the invention, it has been acknowledged that it is thus possible to exclude with a high degree of probability any blocking of the area on which work is to be carried out and, in particular in the case of medical applications, the operating field by positioning the camera, which may be in particular an electronic camera, such as a video camera, on the head of the respective person carrying out the respective activity, e.g. the doctor who is operating. For the simple reason that this person requires a clear view, he or she will ensure that no object or other person is located between his/her head and the area on which he or she is working i.e. for instance the opening field.

According to the invention, a headlamp/camera unit is to be created with at least one illuminant and—in particular—an electronic camera that is attached to a fixture that can hold at least one lamp and the camera on a person's head. The holding device can, for instance, be or/a headband or a cap or helmet.

According to the invention, it has also been recognized that even with the camera attached to the head, and, in particular, to the forehead of a person operating it, there is still no definite guarantee that the area of primary interest is actually in the centre of the image field. According to the invention, therefore, provision is to be made for an optical sighting device, which projects at least one marker into the image field that is illuminated by the lamp.

This enables the operator, who is carrying the camera on his or head to check at any time whether the interesting area is in the centre of the field which the camera is filming. If in a given case it is intended for this area to be elsewhere than the centre, or if for the purposes of documentation, specific sequences of the surrounding area are to be filmed, the person operating the camera can easily achieve this by moving his or her head accordingly.

In other words, the sighting device enables the person operating the camera, which he or she is wearing, to film specific scenes without the need to watch a monitor or similar device.

In order to obtain a particular effective illumination of the image field special preference is given to lamps or lamp with a light emitting area or high emitting areas that surround(s) the camera lens.

The sighting device may be developed in the most varied manner. For instance, the sighting device may project the marker into the centre of the image field filmed by the camera. The person operating the camera thus always knows which spot is located in the centre of the image being filmed. This development has the advantage that only one marker has to be projected.

Alternatively or additionally, the optical sighting device can project seven markers. It is thus possible for the markers to demonstrate the limits of the image field. This development has the advantage that the person operating it is always informated about the outside limit of the area being filmed.

In a different development of the invention the markers unite to form single point if the spot they fall upon is located within the focusing area of the camera. This development has the advantage that, particularly if the camera does not have autofocus, the person operating it is always informed whether the area filmed is within the sharpness range of the camera.

An unlimited number of designs, are possible for the development of the optical sighting device, for instance the optical sighting device can include at least one laser pointer.

If the markers, which essentially, help the person operating the camera to establish positions, cause a disturbance when viewing the image being filmed, the markers on the image in the camera unit can be suppressed electronically or optically.

Devices can be used as lighting devices that are similar to those used for endoscopy. Of course, if high performance lamps are used, it is possible to use IR barrier filters etc: In the case of one favored development of the invention, the lighting device has at least one optical fibre into which the illuminating light is coupled, with a lens fitted into the light emitting end, which throws the cone of light emitted onto the image field. It is particularly favored if provision is made for a large number of optical fibres, and a lens is allocated to each fibre in such manner that the light beams of the individual optical fibres are superimposed on the image field of the camera.

For this purpose it is particularly advantageous if each optical fibre has a diameter of approximately 0.5 mm. The light emitted by such fibres can easily be expanded to a diameter of 100 mm and over with the use of little lenses implanted near to the light-emitting end of the optical fibres with the usual 60- to 80-centimetre working intervals. The lenses can even be an integral part of the light emitting end, produced by the appropriate, superficial fusion of the end.

If, for example, one uses approximately 100 fibres, their light emitting ends can be positioned in more or less circular form around the camera lens, directing the light of a lighting installation with several 100 watts onto the image field of the camera. Typically, the lighting installation has at least one lamp and, particularly a gas discharging lamp, the light of which is coupled into the optical fibres.

Alternatively, the lighting installation may have at least one light diode. The at least one light diode can be positioned directly on the camera head forming the illuminates. White high diodes or diodes that radiate in the UV a IR range can be used as light diodes.

The development according to the invention results in such a bright patch of light that this is even visible under the light of an operating lamp. This even makes it possible to do without a separate optical sighting device with its own source of light, such as a laser pointer. The bright patch of light that results from the superimposed light of the individual fibre then acts as the target marker even if the ambient lighting is bright.

A wide variety of cameras can be used for the camera, for instance electronic cameras or traditional still cameras. However, the preferred type is a video camera, particularly one with an automatic focusing function.

Holding devices, such as headband or caps are well known from a variety of applications and, in particular, medical applications. Equally, suitable minator-cameras including their control area selection units and lighting arrangements are well know. Circular lights are also available that can be arranged in the form of a ring around camera lens, illuminating the image field of the camera, even if the camera has a zoom lens and/or exchangeable lens.

Alternatively, and preferably, it is also possible to adapt the patch lit up by the lighting installation to the image field of the respective lens used or to the focal length set on the zoom lens.

In a further version of the invention, in order to create a fixed physical relationship between the camera and at least on further unit attached to the headband or cap, the holding device has rigid element to which the camera and the further unit are attached.

The rigid element may be attached to the headband or cap. Alternatively, the rigid element may be a rigid ring that forms an integral part of the headband or cap.

In view of the fact that, by contrast with a flexible headband, a rigid ring does not adapt to the shape of the respective wearer's head, it is preferable if at least one inflatable pad is attached to the inside of the rigid ring, serving to adapt it to the shape of the wearer's head.

With regard to a further unit; it may basically be one of a broad variety of units, such as a processing laser. In the case of a preferred further development of the invention, the ′further unit is also a video camera. It facilitates filming from a variety of perspectives or in stereo.

The supply units for the lamps and the camera unit should preferably be part of a separate arrangement from the head unit and connected to the unit according to the invention by means of at least one cable. Preferably, the cable should be equipped with numerous optical fibres, conducting the light of at least one lamp to the illuminant(s).

In particular, the cable may contain a large number of optical fibres, conducting the light from at least one source to the illuminant(s).

In order to keep disturbances to the person wearing the head unit to a minimum, special preference is given to a light installation and camera control and energy supply unit that are connected to the camera and the illuminant(s) by a single cable.

A particularly simple structure is achieved by arranging the lighting installation and the camera control and energy supply unit as modules in a single housing with a multiple plug for the single cable, which combines a number of serial plugs for the various functions such as the connection of light conducting cables, the operation of a laser module or video module etc. in a single multiple plug housing; thus all the serial plugs can be plugged into corresponding sockets on the respective modules.

The unit according to the invention is not only suitable for documenting procedures, but also for “online transmissions” to other workplaces.

In order to facilitate communication between the person wearing the head unit and third parties, preference is also given to provision for an audio module, enabling, in particular, two-way communication to take place between the person wearing the unit and a remote “workplace”. This enables a person at a different workplace to give the person wearing the head unit instructions and/or assistance for the respective work being carried out.

To this end it is particularly advantageous if provision is made for the video module, which facilitates the transmission of the images filmed to the remote “workplace”.

Preference is always given to wireless transmissions of audio and/or video signals. A particularly simple transmission of video signals is possible if the video signals are transmitted in compressed form, for instance in compliance with MPEG IV.

In order to keep the burden on the person wearing the head unit down to a minimum, it is preferable for the module to be positioned separate from the head unit.

Communication between the person wearing the head unit and third parties is further improved if the unit has a head-up display. Alternatively or additionally it is possible for a person at a remote workplace to control the optical sighting device and in particular to aim it at a target, which the person operating it can recognize. The operator at a remote workplace can thus guide the person wearing the head unit by scans of the sighting device.

As has already been stated, it is practical if the module is not attached to the holding device. In order not to impede the freedom of movement of the person wearing the head unit, it is particularly useful if provision is made for a portable control and energy supply unit.

In order to facilitate a long working period, it is useful if the control and energy supply unit has a fuel cell with a liquid gas reservoir. The control and energy supply unit can be carried in a rucksack.

It is also possible to make provision for an archiving system, a picture processing unit and/or display unit.

Based on the above description, an expert working in the relevant field can produce a headlamp/camera unit according to the invention at any time; it is therefore possible to do without the description of an embodiment based on drawings.

1. Headlamp/camera unit particularly for medical applications with
a—particularly electronic camera, such as a video camera,
a lighting installation with at least one illuminant, emitting through its light emitting area the light for illuminating the image field of the camera, and
a holding device to hold the at least one illuminant and the camera on the head of a person, and which is characterized by the provision made for an optical sighting device that projects a minimum of one marker onto the image field of the camera, which is illuminated by the illuminant.

2. Unit pursuant to claim 1, characterized by the fact that the sighting device projects the marker into the centre of the image field filmed by the camera.

3. Unit pursuant to claim 1, characterized by the fact that the optical sighting device projects several markers.

4. Unit pursuant to claim 3, characterized by the fact that the markers demonstrate the limits of the image field.

5. Unit pursuant to claim 3, characterized by the fact that the markers unite in a single point if the location where they converge is within the focus field of the camera.

6. Unit pursuant to one of the claim, between 1 and 5 characterized by the fact that the optical sighting device carries at least one laser pointer.

7. Unit pursuant to the claims between 1 and 6, characterized by the fact that the markers in the image of the camera unit are suppressed electronically or optically.

8. Unit pursuant to one of the claim between 1 and 7, characterized by the fact that the illuminating device has at least one optical fibre into which the illuminating light is coupled and the light emitting end of which, together with a lens, projects the light cone emitted onto the image field of the camera, thus forming the light emitting area of the illuminant.

9. Unit pursuant to claim 8, characterized by the fact that provision is made for large number of optical fibres and that lens is allocated to each optical fibre in such manner that the light beam of the individual optical fibres are superimposed on the image field of the camera.

10. Unit pursuant to claim 9, characterized by the approximately 0.5 mm diameter of each optical fibre.

11. Unit pursuant to one of the claims between 8 and 10, characterized by the fact that the bright patch of light formed by the superimposition of the light of the individual fibres serves as a target marker even if the ambient light is bright.

12. Unit pursuant to one of the claims between 8 and 11, characterized by the fact that the lighting installation has at least one lamp and in particular, a gas discharging lamp, the light of which is coupled into the optical fibre(s).

13. Unit pursuant to the claims between 1 and 11; characterized by the fact that the lighting installation has at least one light diode.

14. Unit pursuant to claim 13, characterized by the fact that at least one light diode is positioned directly on the camera head and forms the illuminant(s).

15. Unit pursuant to claim 13 or 14, characterized by the fact that the light diode(s) are white light diode(s) or diodes that radiate in the UV or IR range.

16. Unit pursuant to the claims between 1 and 15, characterized by the fact that the illuminants or the light emitting area of an illuminant surround the lens of the camera.

17. Unit pursuant to the claims between 1 and 16, characterized by the fact that the camera is a video camera, in particular with an autofocus device.

18. Unit pursuant to claim 17, characterized by the fact that the video camera has a zoom lens and/or exchangeable lenses.

19. Unit pursuant to claim 18, characterized by the fact that the patch lit up by the illuminant(s) is adjusted to the image field of the respective lens in use or the focal length set on the zoom lens.

20. Unit pursuant to the claims between 1 and 19, characterized by the fact that the holding device has a headband or cap.

21. Headlight/camera unit in particular for medical applications in particular with an electronic camera, such as a video camera,
a lighting installation with a minimum of one illuminant from the light emitting area of which the light is emitted to illuminate the image field of the camera and a holding device that holds the minimum of one illuminant and the camera on the head of a person,
or, pursuant to the claims between 1 and 20, characterized by the fact that in order to create a fixed physical relationship between the camera and at least one further unit positioned on the headband or cap, the holding device has a rigid element in which the camera and the further unit are attached.

22. Unit pursuant to claim 21 characterized by the fact that the rigid element is attached to the headband or cap.

23. Unit pursuant to claim 22 characterized by the fact that the rigid element is a rigid ring.

24. Unit pursuant to claim 23 characterized by the fact that at least one inflatable pad is attached to the inner ring of the rigid ring for the purpose of adjustment to the shape of the head of the respective wearer.

25. Unit pursuant to the claims between 2 and 24, characterized by the fact that the further unit is also a video camera.

26. Unit pursuant to claim 25 characterized by the fact that the two video cameras make it possible to film in stereo.

27. Unit pursuant to one of the claims between 1 and 26, characterized by the fact that the lighting installation and a camera control and energy supply unit are positioned separately from the head unit and are connected to the illuminant(s) by at least one cable.

28. Unit pursuant to claim 27 characterized by the fact that the cable had multiple optical fibres that direct the light of at least one light source to the illuminant(s).

29. Unit pursuant to claim 27 or 28 characterized by the fact that the lighting installation and the camera control and energy supply unit are connected to the camera and illuminant(s) by means of single cable.

30. Unit pursuant to claim 29, or the collective term of claim 1.
characterized by the fact that the lighting installation and the camera control and energy supply and are positioned as modules in a single housing and that provision is made for a multiple plug for the several cables, which unites a number of serial plugs for the different functions such as connecting light conducting cables, operating a laser module or a video module or a etc. in a multiple plug housing so that all serial plugs can be plugged in together.

31. Unit pursuant to the collective term of claim 1 or to one of the claims between 1 and 30, characterized by the fact provision is made for an audio module that facilitates in particular two-way communication between the person wearing the unit and a remote “workplace”.

32. Unit pursuant to claim 1 or to one of the claims between 1 and 30, characterized by the fact that provision has been made for video module that facilitates the transmission of the filmed image to a remote “workplace”.

33. Unit pursuant to claim 31 or 32, characterized by the fact that the transmission of audio and/or signals takes place without wire.

34. Unit pursuant to claim 33, characterized by the fact that the video signals are transmitted in compressed form, for instance in compliance with MPEG IV.

35. Unit pursuant to claims between 31 and 34, characterized by the fact that the modules are positioned separate from the head unit.

36. Unit pursuant to collective term of claim 1 or pursuant to one of the claims between 1 and 34, characterized by the fact that provision is made for a module that facilitates two-way communication between the unit and a “remote workplace”.

37. Unit pursuant to claim 36, characterized by the fact that a person operating at a remote workplace can transmit information to the person wearing the unit.

38. Unit pursuant to claim 37, characterized by the fact that the unit has a head-up display for this purpose.

39. Unit pursuant to claim 37 or 38, characterized by the fact that a person operating it controls the optical sighting device at a remote workplace and, in particular directs it towards a target recognized by the person operating the device.

40. Unit pursuant to the collective form to claim 1, characterized by the fact that provision is made for a control and energy supply unit that is portable.

41. Unit pursuant to claim 28 characterized by the fact that the control and energy supply unit is kept in a rucksack.

42. Unit pursuant to claim 40 or 41 characterized by the fact that the control and energy supply unit has a fuel cell with a liquid gas reservoir.

43. Unit pursuant to one of the claim between 1 and 42, characterized by the fact that provision is made for an archiving system.
